(19) United States
(12) Patent Application Publication
(10) Pub. No.: US 2024/0099818 A1
(43) Pub. Date: Mar. 28, 2024

(54) DENTAL IMPLANT ASSEMBLY

(71) Applicant: NEOSS LIMITED, Harrogate, Yorkshire (GB)

(72) Inventor: Fredrik ENGMAN, Göteborg (SE)

(21) Appl. No.: 18/263,330

(22) PCT Filed: Jan. 27, 2022
(86) PCT No.: PCT/GB2022/050218

§ 371 Date: Jul. 27, 2023

(30) Foreign Application Priority Data
Jan. 28, 2021 (GB) 2101193.7

(51) Int. Cl. A61C 8/00

(52) U.S. Cl. CPC A61C 8/008; A61C 8/0012; A61C 8/0074

(57) ABSTRACT

A dental implant assembly may be provided with a spacer removably attachable to a dental implant, a cap removably attachable to the spacer, and a surgical barrier that may be at least partially disposed between the cap and the spacer. The spacer may include a first end configured to engage with the dental implant and a second end configured to engage with the cap. The second end may further include a tool connection region. The surgical barrier may include an outer membrane and an inner mesh enclosed within the outer membrane. A cap head may be provided with a lower surface configured to engage with the surgical barrier. A cap body may be provided with a threaded profile engageable with a threaded connection of the second end of the spacer. At least part of the surgical barrier may be sandwiched between the spacer and the lower surface of the cap.

This invention relates to a dental implant assembly for use in surgery, particularly dental surgery, to a spacer and to a surgical barrier used in the dental implant assembly.

### BACKGROUND

There is a need to provide a dental implant assembly with the ability to prevent ingress of bacteria and/or soft tissue post-implantation.

Dental surgeries employ a variety of techniques to reconstruct the hard tissue prior to the tooth implantation. It is important to have as much hard tissue available for the surgeon as possible in order to replace a tooth root with an implant and then as a next step to attach an artificial tooth to the implant. One of the techniques is to use a perforated mesh to assist the bone regeneration process, particularly in the cases where the amount of bone available for implantation is not adequate or not thick enough, especially its buccal part.

Mesh of this type is disclosed, for example in U.S. Pat. Nos. 4,598,011 and 5,380,328A which disclose titanium mesh to assist in the growth of bone and tissue after trauma, disease and surgery. To facilitate and improve the clinical result and handling, additional solutions have been proposed such as that described in KR20170025213A which describes attaching a perforated mesh to an implant with a fixture via an opening in the mesh. The mesh can be cut to various shapes to match the size of the defect to be fixed. A disadvantage of such an assembly is that the mesh does not prevent soft tissue ingrowth nor the population of the implant site with harmful bacteria. On the contrary, it provides a plurality of the through-holes to allow blood circulation, so that the mesh is in direct contact with the surrounding soft tissues that can eventually penetrate through the holes.

Another example of a reinforcing mesh is the SmartBuilder™ implant assembly (https://hiossen.com/smartbuilder/). The assembly comprises a fixture that is engageable with the bone, an extension that is attachable to the fixture, a SmartBuilder™ membrane with a plurality of holes, that can be shaped depending on the type of augmentation required, and a healing, or cover, cap that is screwed into the extension to fix and hold the mesh in position. The mesh thus creates a defined volume for the post-implantation bone growth. However, such an arrangement has its drawbacks, the main drawback being soft tissue penetration through the plurality of holes, thus preventing the hard tissue to fill up the whole volume and in turn leaving insufficient amount of new bone available for the next step of implantation surgery. Another drawback is the size of the cover cap that in some cases can be detrimental for the surgery. Yet another drawback is that the mesh does not prevent the ingress of bacteria and therefore does not provide any protection against bacterial infection. Finally, another drawback is the requirement for two different connections, or delivery tools, namely a cover cap driver and a cap ejector, for positioning and fixing the parts of the SmartBuilder™ assembly into the bone.

It is therefore an object of embodiments of the invention to at least mitigate one or more of the problems associated with the prior art.

### BRIEF SUMMARY OF THE DISCLOSURE

Aspects and embodiments of the present invention provide a dental implant assembly, a spacer and a surgical barrier, as claimed in the appended claims.

In accordance with the present invention there is provided a dental implant assembly comprising:
a spacer removably attachable to a dental implant;
a cap removably attachable to the spacer, and
a surgical barrier for preventing ingress of bacteria and soft tissue, said barrier at least partially disposed between the cap and the spacer;
wherein the spacer comprises a first end comprising a connection, preferably a threaded connection, configured to engage with the dental implant, and a second end comprising an internal connection, preferably a threaded connection, configured to engage with the cap, said second end further comprising a tool connection region for receiving a screwdriver;
wherein the surgical barrier comprises an outer membrane and an inner mesh,
said inner mesh being enclosed within the outer membrane and wherein said inner mesh provides the surgical barrier with a configurable structure, by being bendable into a desired shape;
wherein the cap comprises a head and a body,
said head comprising a lower surface configured to engage with the surgical barrier;
said body comprising a threaded profile engageable with the internal threaded connection of the second end of the spacer; and
said head further comprising a tool connection region for receiving a screwdriver, and
wherein at least part of said surgical barrier is sandwiched between the spacer and the lower surface of the cap and wherein the inner mesh includes an aperture whose diameter is greater than an outer diameter of the body of the cap.

Advantageously, such an assembly provides optimal conditions for bone regeneration by providing a non-penetrable surgical barrier that does not allow either bacteria or soft tissue to penetrate into the area of bone growth. This prevents contamination of the regeneration site whilst allowing enough space for the bone to re-grow in the space defined by the surgical barrier. The barrier and the cap can be fully or partially covered by soft tissue depending on the treatment options and healing process. The barrier is expected to function for sufficient time for the tissue to regenerate before it is removed by unscrewing the cap. The spacer is usually also removed at the same time but optionally it can remain in place, depending on the subsequent surgical steps required for the implantation.

In an embodiment, the second end of the spacer further comprises an upper supporting surface for supporting the surgical barrier thereon. Advantageously, this allows for a better fixation of the surgical barrier in between the cap and the spacer, thus avoiding undesired dislocations of the implant assembly.

In another embodiment, the inner mesh and/or the spacer, or portions thereof, comprises a metal or metal alloy, for example titanium or titanium alloy. Advantageously, the titanium or titanium alloy provides a strong and light biocompatible material that fuses well with the bone and thus allows to increase clinical success rates for the implantation surgeries.

In yet another embodiment, the inner mesh and/or the spacer, or portions thereof, comprises a biocompatible polymer, for example PEEK. Advantageously, this provides a stable, non-degradable and biocompatible barrier that provides support and is resistant to breakdown by host tissues.

In an embodiment, the surgical barrier is at least partially resorbable. This is advantageous when the membrane does not need to be removed, hence a second surgical intervention is avoided.

In another embodiment, the outer membrane at least partially comprises PTFE. Advantageously, this material provides an optimal combination of mechanical and chemical properties, thus making it suitable for use in dental surgery.

In yet another embodiment, the surgical barrier comprises a high-density polymer impenetrable to bacteria. Advantageously, the high-density polymer prevents ingress of bacteria through the barrier into the bone cavity, thus preventing infection of the implantation site and avoiding the need to use antimicrobial agents to treat bacterial infection.

In another embodiment, the outer membrane comprises an opening for receiving the body of the cap. Advantageously, the presence of the opening allows for ease of use and better alignment of the components of the implant assembly. Thus, when the opening is present, the cap can be more easily aligned with the female threaded connection of the spacer and can also provide a tighter connection between the lower surface of the cap, the surgical barrier and the top of the spacer.

In yet another embodiment, the mesh comprises at least one elongated slot in a bend region of the surgical barrier. Advantageously, the presence of such slots allows for crease- or wrinkle-free bending of the surgical barrier, depending on the type of defect to be covered. The slots allowing for a smoother bending of the surgical barrier are particularly useful for 3- or 2-wall augmentation processes, wherein the tooth is surrounded by three or two walls of bone respectively, and where significant bending of the barrier to shape is required.

In an embodiment, the head of the cap has a height of between 5 and 7 mm. Optionally, the head of the cap has a height of no more than 1 mm. Advantageously, these dimensions allow to control and optimise the size of the assembly, providing the surgeon with a choice of caps to be used depending on the condition and availability of the hard and soft tissues of the specific patient.

In an embodiment, the tool connection region of spacer and the tool connection region of the cap comprise a tool carry function to carry the cap and/or the spacer. This advantageously allows lifting and carrying of the cap and/or the spacer using a screwdriver or other suitable tool.

In another embodiment, the tool connection region of the spacer is located axially below the internal threaded connection towards an apical or lower end of the spacer. Alternatively, the tool connection region of the spacer is at least partially axially coincident with the internal threaded connection. Advantageously, such alternatives affect the overall height of the spacers and thus provide surgeons with a choice of different sizes of the spacer, depending on the specific patient's requirements.

In an embodiment, the tool connection region of the spacer and the tool connection region of the cap are sufficiently similar in size and/or shape to be lifted by the same screwdriver or other suitable tool. Advantageously, this allows to use the same tools for both carrying/lifting the spacer and then for delivering the cap to the implantation site, thus minimising the number of tools required.

In another aspect of the present invention, there is provided a spacer for use in the dental implant assembly described above comprising a first end comprising a threaded connection configured to engage with the dental implant, and a second end comprising an internal threaded connection configured to engage with the cap, said second end further comprising a tool connection region for receiving a screwdriver.

In yet another aspect of the present invention, there is provided a set of differently sized spacers. Advantageously, this allows the surgeon to choose the most appropriate size of the spacer for a wide range of clinical scenarios.

In yet another aspect, there is provided a surgical barrier for use in the dental implant assembly described above comprising an outer membrane and an inner mesh, said inner mesh being enclosed within the outer membrane, wherein said inner mesh provides the surgical barrier with a configurable structure, by being bendable into a desired shape and wherein the inner mesh includes an aperture for receiving the body of a cap.

### BRIEF DESCRIPTION OF THE DRAWINGS

Embodiments of the invention will now be described, by way of example only, with reference to the accompanying drawings wherein:

FIG. 1 is a cross-sectional view of an implant assembly according to an embodiment of the invention, implanted in bone;

FIG. 2 is a cross-sectional view of an embodiment of the spacer;

FIG. 3 is a cross-sectional view of an alternative embodiment of the spacer;

FIG. 4 is a top view of the spacer of FIG. 3;

FIG. 5 is a top view of the spacer of FIG. 2;

FIG. 6 is a cross-sectional view of an embodiment of the cap;

FIG. 7 is a perspective view of an embodiment of the surgical barrier;

FIG. 8A is a perspective view of the surgical barrier of FIG. 7 in its planar, as supplied, condition;

FIG. 8B is a perspective view of an embodiment of the surgical barrier supplied with no opening in the outer membrane; and

FIG. 9 is an exploded perspective view of the implant assembly.

### DETAILED DESCRIPTION

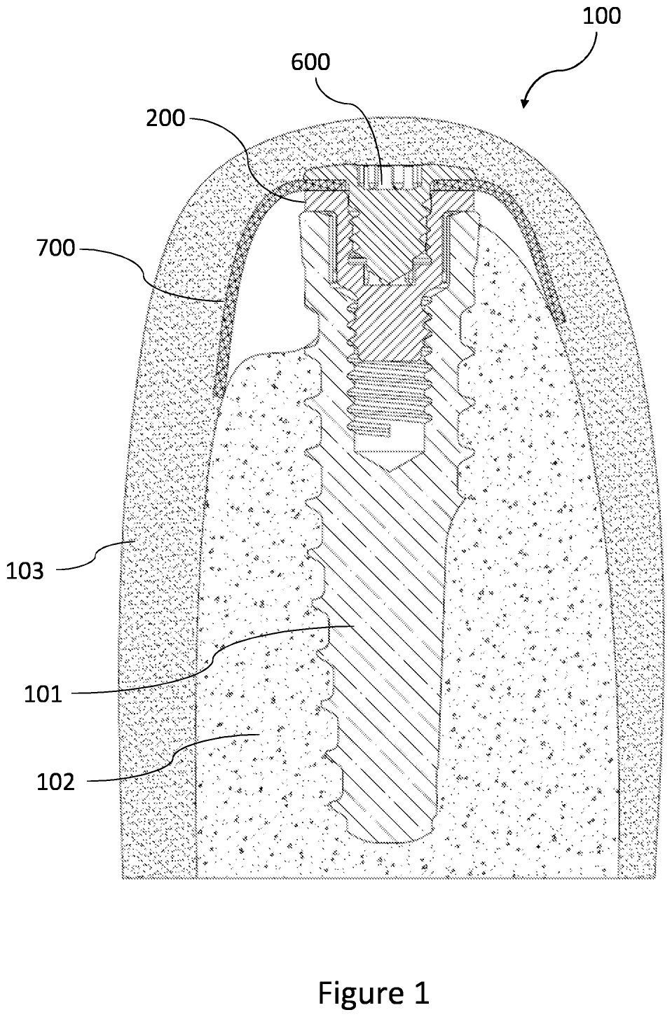

FIG. 1 shows a dental implant assembly 100 according to an embodiment of the present invention. A typical implant 101 is shown inserted into hard tissue 102. Hard tissue can be a bone tissue, for example, a jaw bone. The hard tissue 102 is fully or partially covered by a soft tissue 103. The soft tissue can be, for example, a gingiva or an oral mucosa. The dental implant assembly 100 comprises a spacer 200 that is removably attachable to the dental implant 101. The assembly 100 further comprises a cap 600 and a surgical barrier 700 disposed between the cap 600 and the spacer 200. The spacer 200 may be inserted into the implant 101 by means of a screw thread, though other connection means are also contemplated, such as press fit, snap fit or undercut suitable to receive an O-ring.

The cap 600, in turn, can also be removably affixed to the spacer 200 by means of a screw thread, though other connection means, such as press fit, snap fit or undercut suitable to receive an O-ring, are contemplated. The surgical barrier 700 is placed between the cap and the spacer prior to assembly with the implant. Alternatively, the components can be assembled sequentially, i.e. the spacer is affixed to the implant, then the surgical barrier is positioned onto the spacer, and then the cap is inserted to fix the barrier in the desired position.

Both methods of assembling the cap, the surgical barrier and the spacer provide a stable and tight connection, which enables the implant assembly to withstand high mechanical loads. The implant assembly 100 assembled in the way described above provides a barrier between the soft tissue and the hard tissue by way of “sealing” the implantation site using the surgical barrier 700 and thus preventing the undesired migration of the soft tissue into the area of expected hard tissue growth, as well as preventing harmful bacteria from penetrating and developing under the barrier potentially leading to infection.

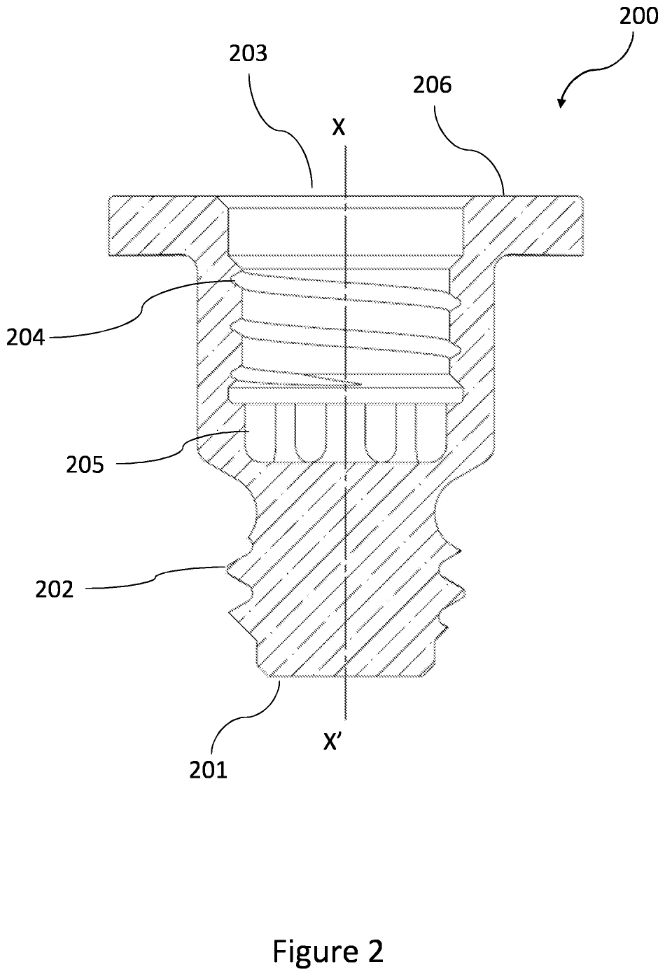

FIG. 2 is a cross-sectional view of the spacer 200 according to an embodiment of the present invention. A top view of the spacer 200 is shown in FIG. 5. The spacer 200 comprises a first apical or lower end 201 with an external threaded connection 202 for engaging with the implant 101, a second end 203 comprising an internal threaded connection 204 for accommodating the cap 600, and a longitudinal axis X-X′. Internal threaded connection 204 minimises the total volume taken up by the implant assembly when implanted into the defect by reducing the overall height. In known implant assemblies such as Smartbuilder™, the healing cover cap significantly protrudes above the surface of the fixture due to the outwardly pointing male threaded connection required to accommodate the cap. KR20170025213A discloses a similar arrangement wherein the top part of the fixture projects above the membrane. This disadvantage can be alleviated by using an internal threaded connection, whereby the male part (body) of the cap is located inside the spacer 200.

The second end 203 of the spacer also provides access to a tool connection region 205 for engaging with a screwdriver or other suitable tool (not shown). The geometry of the tool connection region 205 enables the spacer 200 to be lifted and carried into position by the screwdriver, by means of a friction fit or press fit thereon. In the embodiment shown in FIG. 2, the tool connection region 205 is located axially below the internal threaded connection 204 towards the apical end 201 of the spacer 200. FIG. 5 shows how the tool connection region 205 is accessible through the internal threaded connection 204. Alternatively, the tool connection region could be positioned axially above the threaded connection 204 (not illustrated).

The second end 203 of the spacer 200 further comprises an upper supporting surface 206 which provides a flat and stable surface for supporting the surgical barrier 700 (as shown in FIG. 1).

The spacer 200 may be manufactured from metal, such as titanium or titanium alloy, or polymer material, such as PEEK. These inert toxic-free materials provide excellent biocompatibility and resistance to corrosion, as well as promote osseointegration thus improving clinical outcomes.

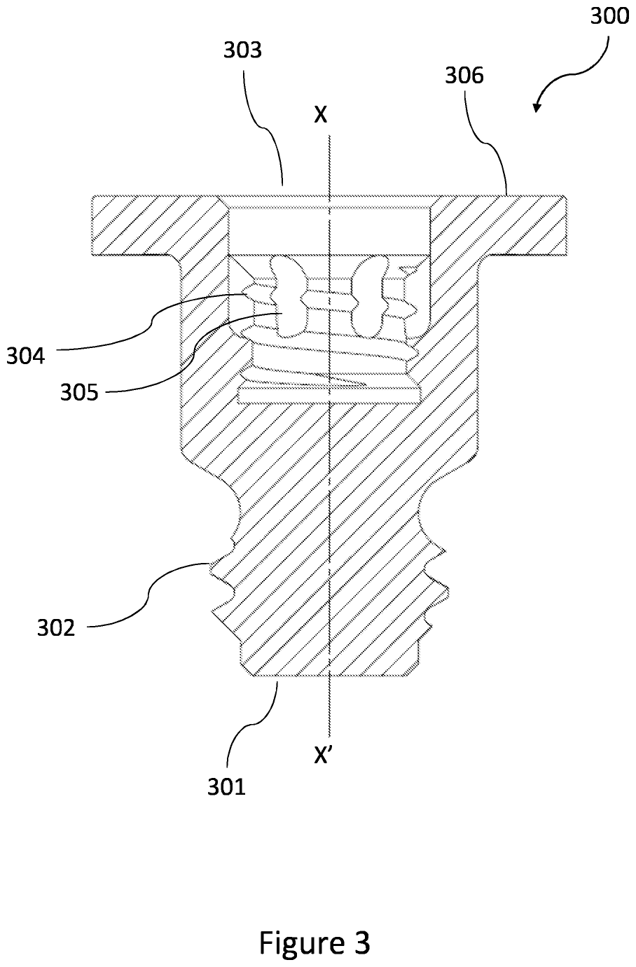

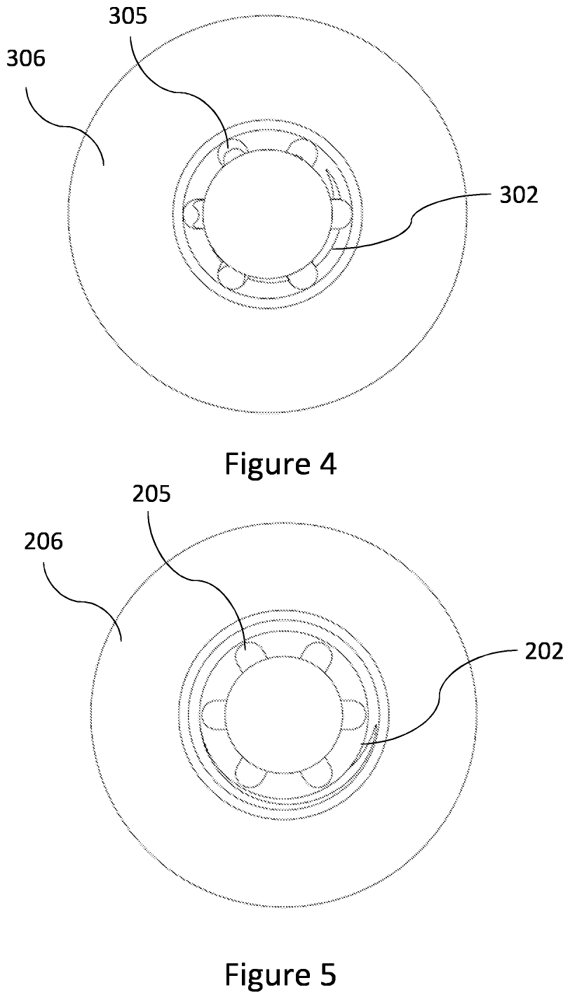

FIG. 3 shows an alternative embodiment of the spacer 300. A top view of the spacer 300 is shown in FIG. 4. The spacer 300 comprises a first apical or lower end 301 with an external threaded connection 302 for engaging with the implant 101, a second end 303 comprising an internal threaded connection 304 for accommodating the cap 600 and an upper surface 306 for supporting the surgical barrier 700, and a longitudinal axis X-X′.

The spacer 300 further comprises a tool connection region 305 for engaging with the screwdriver. In this embodiment, the tool connection region 305 of the spacer 300 is at least partially axially coincident with the internal threaded connection 304. When the tool connection region 305 is at least partially axially coincident with the internal threaded connection 302, the overall height of the spacer 300 can be significantly reduced. This is advantageous when a smaller implant assembly needs to be used; the size of the implant assembly may depend either on the age/gender/age of the patient or on the size of the defect to be fixed. The availability of spacers of different sizes allows the surgeon to choose the most clinically suitable assembly, depending on the surgical needs.

The spacers 200, 300 can be supplied as a set having different sizes in order to provide the surgeon with the choice of sizes to provide the best fit of the implant assembly depending on the size of the jaw bone of the patient.

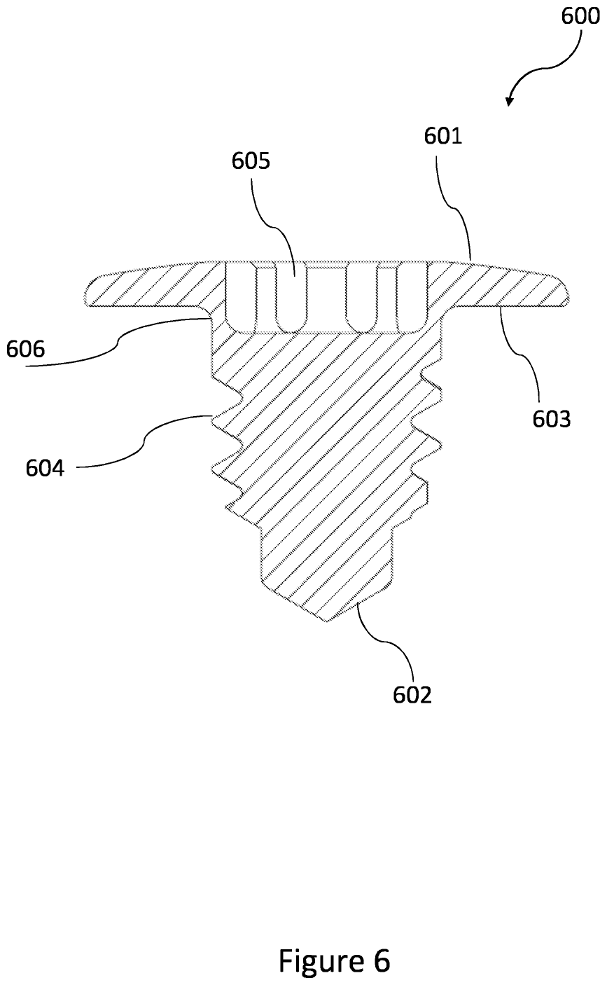

FIG. 6 shows a cap 600 according to an embodiment of the present invention. The cap 600 comprises a head 601 and a body 602. The head 601 comprises a substantially planar lower surface 603 to engage with the surgical barrier 700 and the upper supporting surface 206, 306 of the spacer, so as to sandwich the surgical barrier 700 between the cap and the spacer in a stable and tight-fitting way. The cap further comprises a region 606 located on the body 602 beneath the lower surface 603. The height of this region is selected according to the thickness of the surgical barrier 700 in order to provide a tight fit when the cap 600 is inserted into the spacer 200, 300.

The body 602 of the cap 600 comprises an external threaded profile 604 for engaging with the internal threaded connection 204, 304 of the spacer. The cap can be made of a biocompatible non-resorbable polymer, for example PEEK or PTFE. The cap can also be at least partially made of biocompatible metal or metal alloy, such as titanium or titanium alloy.

The head 601 of the cap 600 comprises a tool connection region 605 for engaging with a screwdriver or other suitable tool. The geometry of the tool connection region 605 enables the cap 600 to be lifted and carried into position by the tool, by means of a friction fit, press fit or snap fit thereon. The height of the head 601 of the cap 600 is typically in the range between 1 and 7 mm, but may be less than 1 mm where less space for the implantation is available.

The tool connection region of the spacer and the tool connection region of the cap may be sufficiently similar in size and shape to enable the same tool to be used for lifting and carrying both the spacer 200, 300 and the cap 600.

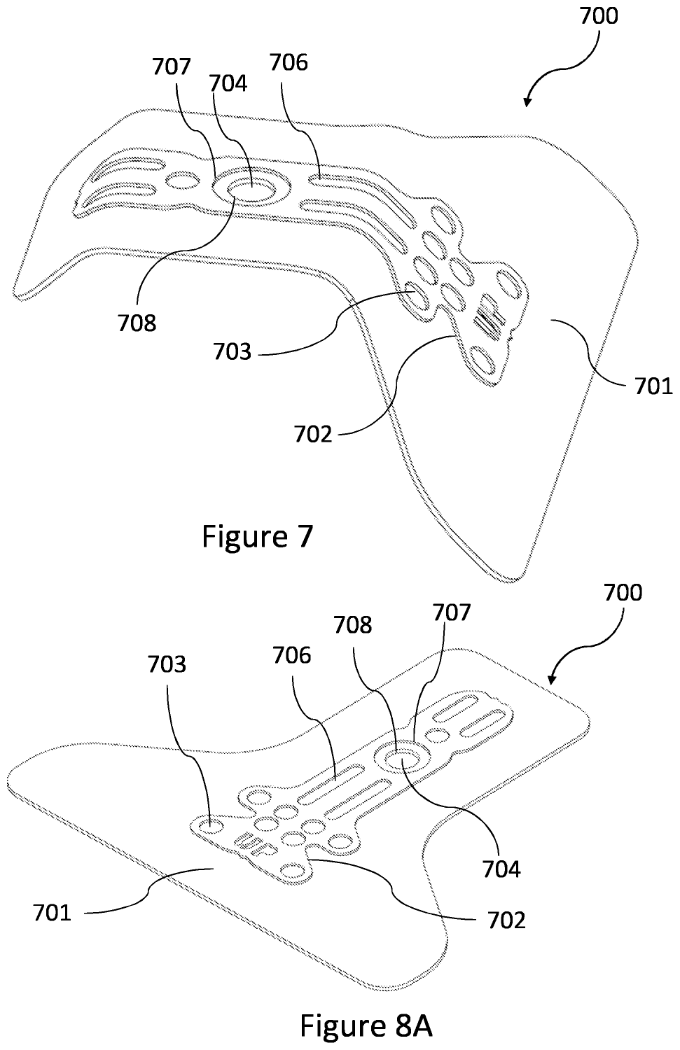

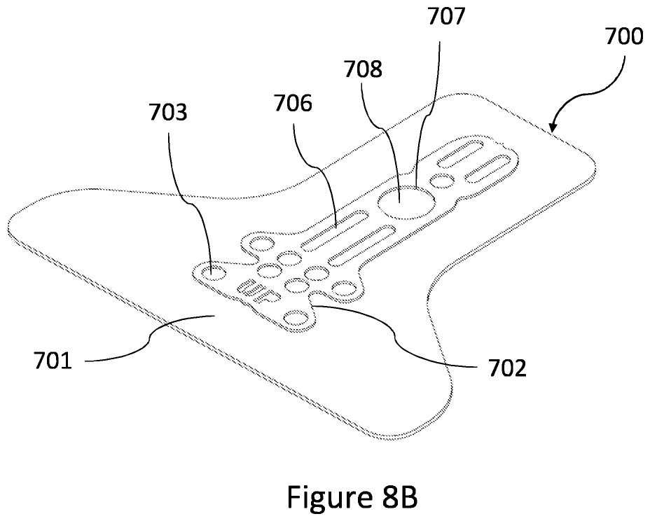

FIGS. 7, 8A and 8B show a surgical barrier 700 according to an embodiment of the present invention. The surgical barrier 700 comprises an outer membrane 701 and an inner perforated mesh 702. The membrane 701 and the mesh 702 form a sandwich structure wherein the inner mesh 702 is preferably fully enclosed within the membrane. The membrane 701 may be moulded around the inner mesh 702 in order to enclose the mesh entirely. Alternatively, the membrane 701 may comprise two layers bonded together with the mesh 702 sandwiched and enclosed therebetween, or the membrane 701 may comprise two or more layers of membrane material with the mesh 702 located between any two of the membrane layers. In an alternative embodiment, the inner mesh 702 is only partially enclosed by the membrane 701.

The surgical barrier 700 can be made of any suitable biocompatible non-resorbable materials, said materials have a density that is high enough to be impenetrable to bacteria. Such materials include, without limitation, PEEK, PTFE and metal alloys. In an alternative embodiment, the polymer is at least partially resorbable. In an embodiment, the membrane 701 at least partially comprises PTFE material. The inner mesh 702 can be made of, for example, PEEK. Alternatively, the mesh 702 can be made of titanium or titanium alloy.

The membrane 701 and the mesh 702 are bonded together to form a monolithic structure. The mesh 702 comprises a plurality of openings or perforations 703 through which each layer of the membrane and the inner mesh can be bonded together. The openings or perforations 703 are generally circular. The mesh 702 also comprises one or more elongated perforation in the form of a slot 706. The slots 706 are located in regions of the surgical barrier where it is desired to facilitate the bending of the barrier into a desired shape (“bend regions”). The slots 706 minimise wrinkling of the membrane 701 covering the mesh 702 in the bend regions.

The mesh 702 includes an aperture 707, preferably a circular aperture, whose diameter is less than the diameter of the head 601 of the cap 600 but greater than the diameter of the body 602 of the cap 600. The periphery of the aperture 707 is the part of the surgical barrier 700 which, in use, is sandwiched between the upper supporting surface 206, 306 of the spacer and the lower surface 603 of the cap. This sandwiching of the mesh 702 between the spacer and the cap gives the dental implant assembly desirable stability. The periphery of the aperture 707 may include a seat (not illustrated) in the mesh 702 for the head of the cap 600 to further improve the stability of the fit of the cap on the surgical barrier 700.

A region 708 of the membrane 701 located within the area of aperture 707 seals the mesh 702 within the membrane 701 so as to minimise ingress of bacteria. As shown in FIG. 7 and FIGS. 8A, the region 708 of the membrane includes an opening 704 which is capable of receiving the body 602 of the cap. The illustrated opening 704 is circular and coaxial with the aperture 707 in the mesh but the opening 704 may be any slot, slit or other suitable opening through which the body 602 of the cap could pass. Preferably, the membrane at the edges of the opening 704 flex against the body 602 of the cap, in use, to provide a better seal.

Alternatively, as shown in FIG. 8B, the region 708 of the membrane is intact when the surgical barrier 700 is supplied. The membrane may be perforated in the region 708, by the surgeon, in order to create the opening 704 in situ.

The circular opening 704 in the membrane is the only aperture through the surgical barrier 700; the perforations 703 and aperture 707 in the mesh 702 are otherwise entirely sealed by the membrane 701.

Although it is known, for example from GB2529488B and to provide a reinforced PTFE membrane, none of these provide the advantages of the claimed invention. GB2529488B relates to a mesh entirely enclosed within two layers of membrane. Known reinforced membranes do not have any opening in the mesh suitable to receive the cap of the present invention, nor any suitable region of the membrane where such an opening could be made.

The surgical barrier 700 is preferably delivered in a substantially planar or flat configuration as depicted in FIGS. 8A and 8B and can be bent into a desired shape as depicted in FIG. 7. Alternatively, the surgical barrier 700 could be delivered having a preformed non-planar configuration as shown in FIG. 7, for example.

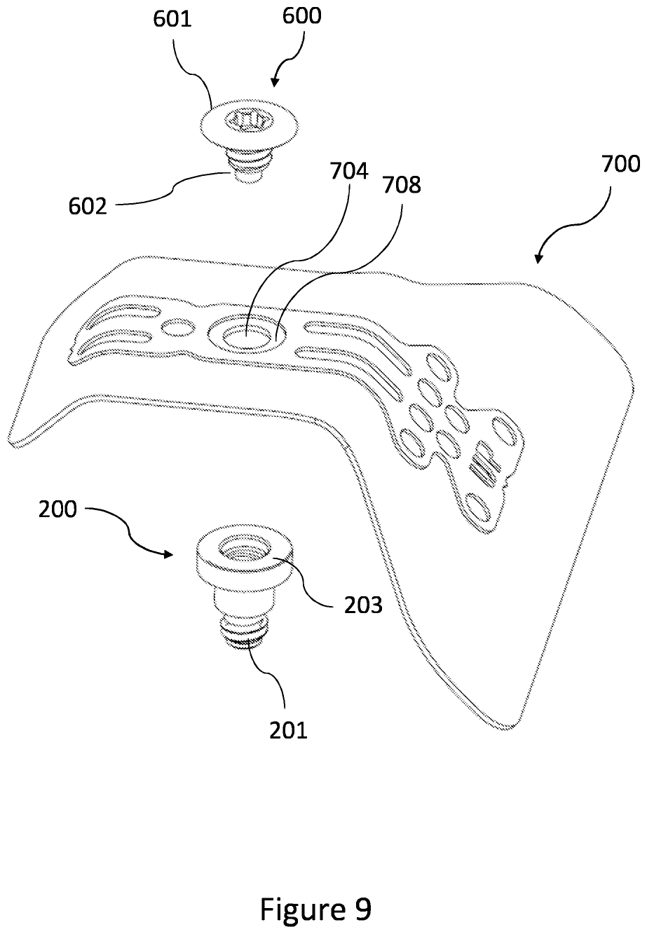

FIG. 9 is an exploded view of the implant assembly 100 ready for assembly.

Throughout the description and claims of this specification, the words “comprise” and “contain” and variations of them mean “including but not limited to”, and they are not intended to (and do not) exclude other additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

A complete listing of the claims follows:

1. A dental implant assembly comprising:
a spacer removably attachable to a dental implant;
a cap removably attachable to the spacer, and
a surgical barrier for preventing ingress of bacteria and soft tissue, said barrier at least partially disposed between the cap and the spacer;
wherein the spacer comprises a first end comprising a connection configured to engage with the dental implant, and a second end comprising an internal connection configured to engage with the cap, said second end further comprising a tool connection region for receiving a screwdriver;
wherein the surgical barrier comprises an outer membrane and an inner mesh,
said inner mesh being enclosed within the outer membrane and wherein said inner mesh provides the surgical barrier with a configurable structure, by being bendable into a desired shape;
wherein the cap comprises a head and a body,
said head comprising a lower surface configured to engage with the surgical barrier;
said body comprising a threaded profile engageable with the internal threaded connection of the second end of the spacer; and
said head further comprising a tool connection region for receiving a screwdriver, and
wherein at least part of said surgical barrier is sandwiched between the spacer and the lower surface of the cap and wherein the inner mesh includes an aperture whose diameter is greater than an outer diameter of the body of the cap.

2. The dental implant assembly of claim 1, wherein the second end of the spacer further comprises an upper supporting surface for supporting the surgical barrier thereon.

3. The dental implant assembly of claim 1, wherein the inner mesh and/or the spacer, or portions thereof, comprises a metal or metal alloy, for example titanium or titanium alloy.

4. The dental implant assembly of claim 1, wherein the inner mesh and/or the spacer, or portions thereof, comprises a biocompatible polymer, for example PEEK.

5. The dental implant assembly of claim 1, wherein the surgical barrier is at least partially resorbable.

6. The dental implant assembly of claim 1, wherein the outer membrane at least partially comprises PTFE.

7. The dental implant assembly of claim 1, wherein the surgical barrier comprises a high-density polymer impenetrable to bacteria.

8. The dental implant assembly of claim 1, wherein the outer membrane comprises an opening for receiving the body of the cap.

9. The dental implant assembly of claim 1, wherein the mesh comprises at least one elongated slot in a bend region of the surgical barrier.

10. The dental implant assembly of claim 1, wherein the head of the cap has a height of between 1 and 7 mm.

11. The dental implant assembly of claim 1, wherein the head of the cap has a height of no more than 1 mm.

12. The dental implant assembly of claim 1, wherein the tool connection region of spacer and the tool connection region of the cap comprise a tool carry function to carry the cap and/or the spacer.

13. The dental implant assembly of claim 1, wherein the tool connection region of the spacer is located axially below the internal threaded connection towards an apical or lower end of the spacer.

14. The dental implant assembly of claim 1, wherein the tool connection region of the spacer is at least partially axially coincident with the internal threaded connection.

15. The dental implant assembly of claim 1, wherein the tool connection region of the spacer and the tool connection region of the cap are sufficiently equal in size and/or shape to be lifted by the same screwdriver.

16. A spacer for use in the dental implant assembly of claim 1, comprising a first end comprising a threaded connection configured to engage with the dental implant, and a second end comprising an internal threaded connection configured to engage with the cap, said second end further comprising a tool connection region for receiving a screwdriver.

17. A set of differently sized spacers as claimed in claim 16.

18. A surgical barrier for use in the dental implant assembly of claim 1, comprising an outer membrane and an inner mesh,
said inner mesh being fully enclosed within the outer membrane;
wherein said inner mesh provides the surgical barrier with a configurable structure, by being bendable into a desired shape and
wherein the inner mesh includes an aperture for receiving the body of a cap.
